(19) United States
(12) Patent Application Publication
(10) Pub. No.: US 2021/0024749 A1
(43) Pub. Date: Jan. 28, 2021

(54) HEAT-CURABLE MALEIMIDE RESIN COMPOSITION AND SEMICONDUCTOR DEVICE

(71) Applicant: Shin-Etsu Chemical Co., Ltd., Tokyo (JP)

(72) Inventors: Shoichi OSADA, Annaka-shi (JP); Norifumi KAWAMURA, Annaka-shi (JP); Kenji HAGIWARA, Annaka-shi (JP); Ryuhei YOKOTA, Annaka-shi (JP)

(73) Assignee: Shin-Etsu Chemical Co., Ltd., Tokyo (JP)

(21) Appl. No.: 16/910,619

(22) Filed: Jun. 24, 2020

(30) Foreign Application Priority Data
Jul. 26, 2019 (JP) 2019-137457

(51) Int. Cl. C08L 79/08; C08K 3/22; H01B 3/30; H01B 19/04

(52) U.S. Cl. CPC C08L 79/08; C08K 3/22; C08K 2201/005; H01B 19/04; H01B 3/306

(57) ABSTRACT

Provided is a heat-curable maleimide resin composition capable of being turned into a cured product with a superior dielectric property, and allowing a plating layer(s) to be formed only at laser-irradiated parts on the surface of or inside the cured product. The heat-curable maleimide resin composition contains:
(A) a cyclic imide compound having, in one molecule, at least one dimer acid backbone, at least one linear alkylene group having not less than 6 carbon atoms, and at least two cyclic imide groups; and
(B) a laser direct structuring additive being a metal oxide having a spinel structure and represented by the following average composition formula (1):

AB₂O₄ (1)

wherein A represents one or more metal elements selected from iron, copper, nickel, cobalt, zinc, magnesium and manganese, B represents iron or chrome, provided that A and B do not both represent iron.

### BACKGROUND OF THE INVENTION

### Field of the Invention

The present invention relates to a heat-curable maleimide resin composition capable of being plated via non-electrolytic plating; and a semiconductor device having a cured product thereof

### Background Art

Semiconductor devices installed in communication devices such as mobile phones and smartphones require materials suitable for high-frequency bands, and it is critical to reduce transmission loss as a countermeasure to noises. Thus, it is required that an insulating material with a superior dielectric property be used in the insulation layer(s).

As an insulating material, there are known, for example, the following materials. JP-A-2011-132507 discloses that an epoxy resin composition containing an epoxy resin, an active ester compound and a triazine-containing cresol novolac resin is effective in lowering dielectric tangent. However, even in the case of this material, an even lower dielectric tangent is required. Further, JP-A-2015-101626 and JP-A-2017-210527 disclose that a resin composition containing an epoxy resin and an active ester compound as essential components is capable of being turned into a cured product with a low dielectric tangent, and that such cured product is useful as an insulating material.

Meanwhile, WO2016/114287 discloses that, as a non-epoxy material, a resin film comprised of a resin composition containing a long-chain alkyl group-containing bismaleimide resin and a curing agent is superior in low-dielectric property.

Further, attempts have also been made to further downsize semiconductor devices installed in communication devices, by forming antennas on the surfaces thereof via metal wiring.

As a method for forming rewiring, electrolytic copper plating or the like is now dominant even though such method includes significantly cumbersome steps such as resist application, pattern formation, washing, sputtering, resist removal and electrolytic plating. In addition, a chemical resistance is required even in resins and chips if performing electrolytic plating.

In this regard, as a method for selectively forming a plating pattern, there has been developed a technique called laser direct structuring (referred to as “LDS” hereunder) (Japanese Unexamined Patent Application Publication (Translation of PCT Application) No. 2004-534408).This technique is such that by adding an LDS additive to a resin, and then using a laser to activate the surface of or the inner region of a cured product of the resin, a plated layer(s) can be formed only in parts that have been irradiated with the laser. This technique is characterized in that a metal layer can be formed on the surface of or inside a cured product without using, for example, an adhesion layer and a resist (JP-A-2015-108123 and WO2015/033295). However, there is a problem that LDS additives are known to impair dielectric property.

### SUMMARY OF THE INVENTION

Therefore, it is an object of the present invention to provide a heat-curable maleimide resin composition capable of being turned into a cured product with a superior dielectric property, and allowing a plating layer(s) to be formed only at laser-irradiated parts on the surface of or inside the cured product.

The inventors of the present invention diligently conducted a series of studies to solve the abovementioned problems. As a result, the inventors found that there could be achieved a cured product that was superior in dielectric property and capable of allowing a metal wiring layer(s) to be easily formed on the surface of or inside such cured product, by combining a particular cyclic imide compound and a laser direct structuring additive of an amount within a particular range.

That is, the present invention is to provide the following heat-curable maleimide resin composition and a semiconductor device having a cured product of such composition.
[1]
   A heat-curable maleimide resin composition comprising:
      (A) a cyclic imide compound having, in one molecule, at least one dimer acid backbone, at least one linear alkylene group having not less than 6 carbon atoms, and at least two cyclic imide groups; and
      (B) a laser direct structuring additive in an amount of 5 to 100 parts by mass per 100 parts by mass of the component (A), the laser direct structuring additive being a metal oxide having a spinel structure and represented by the following average composition formula (1):

AB₂O₄ (1)
wherein A represents one or more metal elements selected from iron, copper, nickel, cobalt, zinc, magnesium and manganese, B represents iron or chrome, provided that A and B do not both represent iron.
[2]
   The heat-curable maleimide resin composition according to [1], wherein an average particle size of the component (B) is 0.01 to 5 μm.
[3]
   The heat-curable maleimide resin composition according to [1] or [2], wherein the component (B) is such that after an aqueous dispersion of the component (B) is prepared by immersing 10 parts by mass of the component (B) in 50 parts by mass of pure water, and then left to stand at 125±3° C. for 20±1 hours, a sodium ion concentration in the aqueous dispersion of the component (B) is not higher than 50 ppm, and a chloride ion concentration in the aqueous dispersion of the component (B) is not higher than 50 ppm.
[4]
   The heat-curable maleimide resin composition according to any one of [1] to [3], wherein the cyclic imide compound as the component (A) is represented by the following general formula (2):

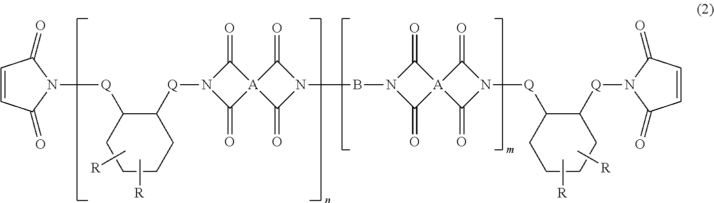

wherein A independently represents a tetravalent organic group having an aromatic ring or aliphatic ring; B represents an alkylene group that has 6 to 18 carbon atoms and a divalent aliphatic ring that may contain a hetero atom; Q independently represents a linear alkylene group having not less than 6 carbon atoms; R independently represents a linear or branched alkyl group having not less than 6 carbon atoms; n represents a number of 1 to 10; m represents a number of 0 to 10.
[5]
   The heat-curable maleimide resin composition according to [4], wherein A in the general formula (2) is represented by any one of the following structural formulae:

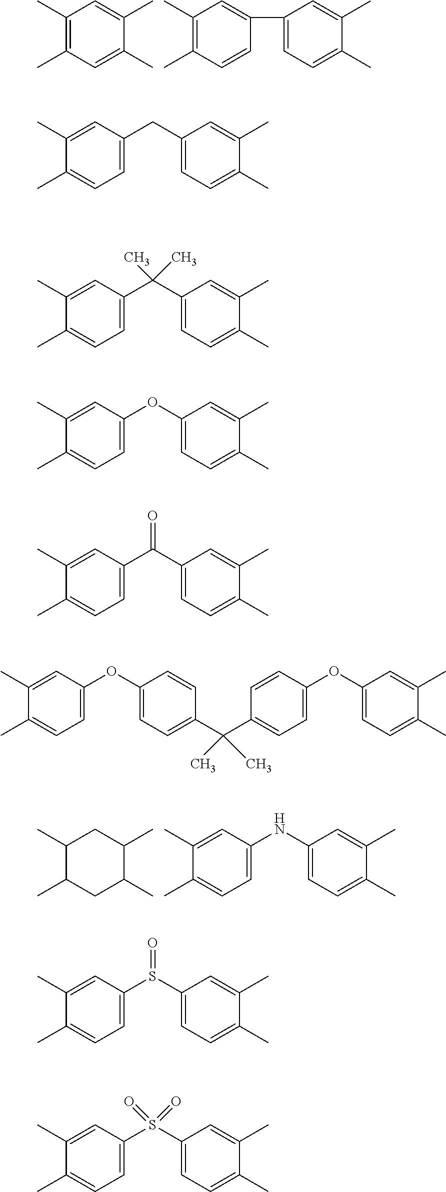

wherein bonds in the above structural formulae that are yet unbonded to substituent groups are to be bonded to carbonyl carbons forming cyclic imide structures in the general formula (2).
[6]
   The heat-curable maleimide resin composition according to any one of [1] to [5], further comprising a mold release agent, an adhesion aid and a curing accelerator.
[7]
   The heat-curable maleimide resin composition according to any one of [1] to [6], further comprising an inorganic filler.
[8]
   A semiconductor device having a cured product of the heat-curable maleimide resin composition according to any one of [1] to [7].
[9]
   The semiconductor device according to [8], wherein at least part of the cured product is plated.
[10]
   A method for producing the semiconductor device according to [9], wherein parts that have been irradiated with a laser are plated.

The cured product of the composition of the present invention is superior in dielectric property, and is capable of allowing a metal layer(s) (plating layer(s)) to be easily and selectively formed on the surface of or inside the cured product. Thus, the composition of the invention is suitable for use in semiconductor devices installed in communication devices, as an insulating material that is superior in dielectric property and capable of allowing antennas or the like to be formed via metal wiring.

### DETAILED DESCRIPTION OF THE INVENTION

### (A) Cyclic Imide Compound

A component (A) used in the present invention is a cyclic imide compound, and is characterized by having, in one molecule, at least one dimer acid backbone, at least one linear alkylene group having not less than 6 carbon atoms, and at least two cyclic imide groups. Since the cyclic imide compound as the component (A) has a linear alkylene group(s) having not less than 6 carbon atoms, the cured product of a composition containing such component has a superior dielectric property. Since the cyclic imide compound as the component (A) has a linear alkylene group(s), the cured product of a composition containing such component is capable of exhibiting a lower elasticity, which is also effective in reducing a stress on a semiconductor device by the cured product.

It is preferred that the cyclic imide compound as the component (A) be a maleimide compound, more preferably a maleimide compound represented by the following general formula (2):

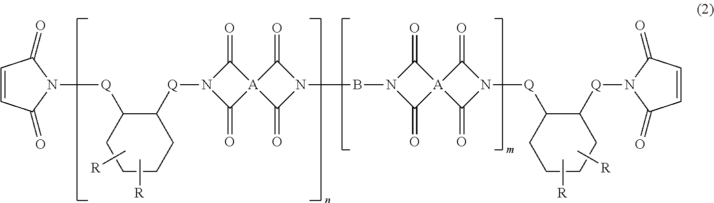

In the general formula (2), A independently represents a tetravalent organic group having an aromatic ring or aliphatic ring. B represents an alkylene group that has 6 to 18 carbon atoms and a divalent aliphatic ring that may contain a hetero atom. Q independently represents a linear alkylene group having not less than 6 carbon atoms. Each R independently represents a linear or branched alkyl group having not less than 6 carbon atoms. n represents a number of 1 to 10. m represents a number of 0 to 10.

While Q in the general formula (2) represents a linear alkylene group having not less than 6 carbon atoms, it is preferred that such linear alkylene group have 6 to 20, more preferably 7 to 15 carbon atoms.

Further, R in the general formula (2) represents an alkyl group which may be either a linear alkyl group or a branched alkyl group, and such alkyl group has not less than 6 carbon atoms. However, it is preferred that this alkyl group have 6 to 12 carbon atoms.

A in the general formula (2) represents a tetravalent organic group having an aromatic ring or aliphatic ring, and is preferably any one of the tetravalent organic groups represented by the following structural formulae:

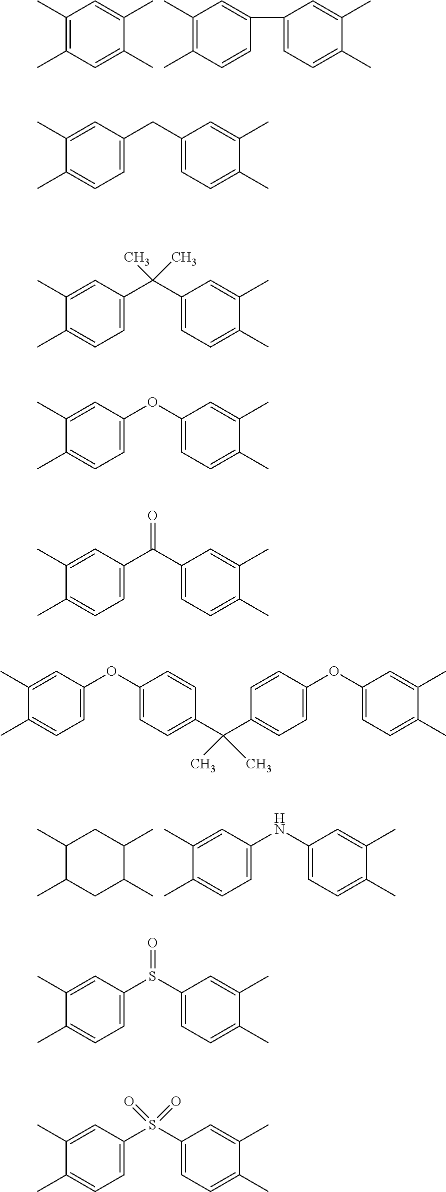

Bonds in the above structural formulae that are yet unbonded to substituent groups are to be bonded to carbonyl carbons forming cyclic imide structures in the general formula (2).

Further, B in the general formula (2) represents an alkylene group that has 6 to 18 carbon atoms and a divalent aliphatic ring that may contain a hetero atom, and it is preferred that such alkylene group have 8 to 15 carbon atoms. It is preferred that B in the general formula (2) be any one of the aliphatic ring-containing alkylene groups represented by the following structural formulae:

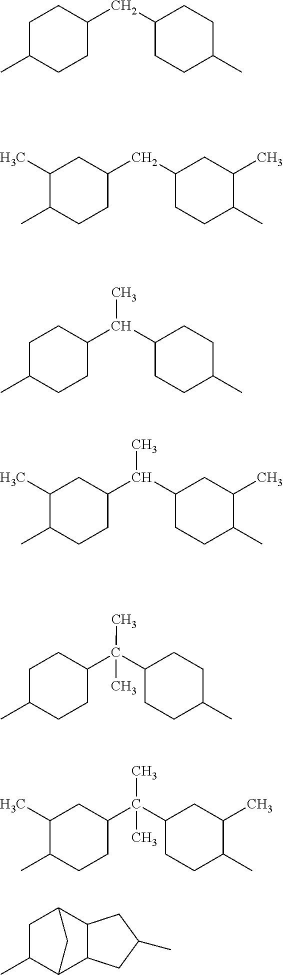

Bonds in the above structural formulae that are yet unbonded to substituent groups are to be bonded to nitrogen atoms forming cyclic imide structures in the general formula (2).

n in the general formula (2) represents a number of 1 to 10, preferably a number of 2 to 7. m in the general formula (2) represents a number of 0 to 10, preferably a number of 0 to 7.

While there are no particular restrictions on the weight-average molecular weight (Mw) of the cyclic imide compound as the component (A) and a state thereof at room temperature (25° C.), it is preferred that a weight-average molecular weight measured by gel permeation chromatography (GPC) be not larger than 70,000, more preferably 1,000 to 50,000, in terms of polystyrene. When such molecular weight is not larger than 70,000, a favorable moldability such as a lamination formability will be exhibited as there exists no concern that a fluidity may deteriorate due to an excessively high viscosity of the composition obtained.

Here, the term “weight-average molecular weight (Mw)” referred to in the present invention means a weight-average molecular weight measured by GPC under the following conditions, using polystyrene as a reference substance.
Measurement condition
Developing solvent: tetrahydrofuran
Flow rate: 0.35 mL/min
Detector: RI
Column: TSK-GEL H type (by TOSOH CORPORATION)
Column temperature: 40° C.
Sample injection volume: 5 μL

As the cyclic imide compound as the component (A), it may be synthesized by a polymerization reaction between a corresponding acid anhydride and diamine, or there may be used commercially available products such as BMI-1500, BMI-3000 and BMI-5000 (all by Designer Molecules Inc.). Further, one kind of cyclic imide compound may be used alone, or two or more kinds thereof may be used in combination.

It is preferred that the component (A) be contained in the composition of the present invention by an amount of 5 to 95% by mass, more preferably 10 to 92% by mass.

### (B) Laser Direct Structuring Additive (LDS Additive)

An LDS additive as a component (B) used in the present invention is a metal oxide having a spinel structure, and is represented by the following average composition formula (1).

AB₂O₄ (1)

In the above formula, A represents one or more metal elements selected from iron, copper, nickel, cobalt, zinc, magnesium and manganese, B represents iron or chrome, provided that A and B do not both represent iron.

Specific examples of such metal oxide include FeCr₂O₄, CuCr₂O₄, NiCr₂O₄, MnCr₂O₄, MgCr₂O₄, ZnCr₂O₄, CoCr₂O₄, CuFe₂O₄, NiFe₂O₄, MnFe₂O₄, MgFe₂O₄, ZnFe₂O₄ and CoFe₂O₄.

There are no particular restrictions on a method for producing these metal oxides as LDS additives. In fact, there may be used those produced by, for example, calcining a metal oxide mixed powder, or oxidizing or performing chemical synthesis on a metal powder mixture.

It is preferred that the LDS additive is in the form of fine particles. In terms of a volume particle size distribution measurement value measured by a laser diffraction-type particle size distribution meter, an average particle size of such fine particles is preferably 0.01 to 5 μm, particularly preferably 0.05 to 3.0 μm. When the average particle size of the LDS additive is 0.01 to 5 μm, a plating property will be improved as the generation of metallic species serving as plating catalysts shall be promoted when a package surface has been irradiated by a laser with the LDS additive being already uniformly distributed in the entire resin.

It is preferred that the LDS additive be added in an amount of 5 to 100 parts by mass, more preferably 10 to 80 parts by mass, per 100 parts by mass of the component (A). When this amount is smaller than 5 parts by mass, the plating property will deteriorate as metal species serving as plating catalysts will be generated in an insufficient manner at the time of performing laser irradiation. When this amount is larger than 100 parts by mass, a dielectric property will be impaired. It is desired that the ratio of the LDS additive in the entire composition be 5 to 9% by mass, if both the plating property and dielectric property are to be satisfied.

Further, when the compounding ratio of the LDS additive in the entire composition is greater than 9% by mass, there will be a higher ratio of metal oxide particles having a small particle size, which may cause deterioration in fluidity and moldability of the composition.

Further, preferred is a type of LDS additive such that after immersing 10 parts by mass thereof in 50 parts by mass of pure water under a condition of 125° C./20 hours, inorganic ion concentrations in the aqueous dispersion that are not higher than certain levels are to be observed; it is particularly preferable when a sodium ion concentration is not higher than 50 ppm, and a chloride ion concentration is not higher than 50 ppm. When the sodium ion concentration and the chloride ion concentration are each higher than 50 ppm, the cured product may exhibit an impaired electric property in a high-temperature and high-humidity environment, which may cause the metal parts of a semiconductor device to be corroded.

Here, in the above immersion condition, an error of ±3° C. is allowed for the extraction temperature, and an error of ±1 hour is allowed for the extraction time. Further, the sodium ion concentration is a value measured by an atomic absorption photometer; and the chloride ion concentration is a value measured by ion chromatography.

Here, if the ion concentrations in a commercially available LDS additive are greater than the above upper limits, this commercially available LDS additive may simply be purified by, for example, being repeatedly washed with water until the ion concentrations reach the preferable levels, and then be dried before use.

### Other Additives

The resin composition of the present invention may further contain an inorganic filler, an adhesion aid, a mold release agent, a curing accelerator, a flame retardant, an ion trapping agent, a flexibility-imparting agent, an epoxy resin, a solvent and other additives, provided that the effects of the present invention will not be impaired.

As an inorganic filler, there may be used materials such as a molten silica, a crystalline silica, cristobalite, alumina, silicon nitride, aluminum nitride, boron nitride, titanium oxide, glass fibers, alumina fibers, zinc oxide, talc and calcium carbide (provided that the aforementioned component (B) is excluded). Two or more of these materials may be used in combination. A top cut particle size of the inorganic filler in a wet sieving method is preferably 5 to 25 μm, more preferably 10 to 20 μm; an average particle size of the inorganic filler is preferably 1 to 10 μm, more preferably 3 to 7 μm, in terms of a volume particle size distribution measurement value measured by a laser diffraction-type particle size distribution meter.

Here, the term “top cut particle size” is defined as follows. That is, with respect to a mesh opening(s) of a sieve used for classification in a wet sieving method for sieving an inorganic filler produced, “top cut particle size” refers to a value at which a ratio of particles larger than these openings is not higher than 2% by volume in terms of a volume particle size distribution measurement value measured by a laser diffraction method. It is preferable when the top cut particle size is not larger than 25 μm, because it will not be difficult to form wiring layers and vias as even a part(s) exposing the surface of the inorganic filler shall be plated when irradiated with a laser.

While there are no particular restrictions on the amount of the inorganic filler added, it may be added in an amount of 1 to 1,000 parts by mass per 100 parts by mass of the component (A) depending on the intended use.

Examples of the adhesion aid include epoxysilanes such as γ-glycidoxypropyltrimethoxysilane, γ-glycidoxypropylmethyldiethoxysilane and β-(3,4-epoxycyclohexyl)ethyltrimethoxysilane; aminosilanes such as N-(β-aminoethyl)-γ-aminopropyltrimethoxysilane, a reactant of imidazole and γ-glycidoxypropyltrimethoxysilane, γ-aminopropyltriethoxysilane and N-phenyl-γ-aminopropyltrimethoxysilane; and mercaptosilanes such as γ-mercaptosilane and γ-episulfidoxypropyltrimethoxysilane. Any one of these adhesion aids may be used alone, or two or more of them may be used in combination.

While there are no particular restrictions on the amount of the adhesion aid added, it is added in an amount of 0.2 to 5 parts by mass, preferably 0.3 to 2 parts by mass, per 100 parts by mass of the component (A).

Examples of the mold release agent include waxes such as a carnauba wax, a rice wax, polyethylene, oxidized polyethylene, montanic acid, and an ester compound of montanic acid with, for example, a saturated alcohol, 2-(2-hydroxyethylamino)-ethanol, ethylene glycol or glycerin; stearic acid, stearic acid ester, stearamide, ethylenebisstearamide, and a copolymer of ethylene and vinyl acetate. Any one of these mold release agents may be used alone, or two or more of them may be used in combination.

While there are no particular restrictions on the amount of the mold release agent added, it is added in an amount of 0.1 to 5 parts by mass, preferably 0.2 to 2 parts by mass, per 100 parts by mass of the component (A).

Examples of the curing accelerator include dicumylperoxide, diisobutyl peroxide, di-t-butylperoxide, 2,5-dimethyl-2,5-bis(t-butylperoxy)hexane and di(2-t-butylperoxyisopropyl)benzene. Any one of these curing accelerators may be used alone, or two or more of them may be used in combination.

While there are no particular restrictions on the amount of the curing accelerator added, it is added in an amount of 0.2 to 5 parts by mass, preferably 0.5 to 3 parts by mass, per 100 parts by mass of the component (A).

Examples of the flame retardant include a halogenated epoxy resin, a phosphazene compound, a silicone compound, a zinc molybdate-supported talc, a zinc molybdate-supported zinc oxide, aluminum hydroxide, magnesium hydroxide, molybdenum oxide and antimony trioxide. Any one of these flame retardants may be used alone, or two or more of them may be used in combination. However, a phosphazene compound, a zinc molybdate-supported zinc oxide and molybdenum oxide are preferably used in terms of environmental burdens and ensuring fluidity.

Examples of the ion trapping agent include a hydrotalcite compound, a bismuth compound and a zirconium compound. Any one of these ion trapping agents may be used alone, or two or more of them may be used in combination.

Examples of the flexibility-imparting agent include silicone compounds such as a silicone oil, a silicone resin, a silicone-modified epoxy resin and a silicone-modified phenolic resin; and thermoplastic elastomers such as a styrene resin and an acrylic resin. Any one of these flexibility-imparting agents may be used alone, or two or more of them may be used in combination.

Further, as long as the dielectric property will not be impaired, there may be used a novolac-type epoxy resin such as a phenol novolac-type epoxy resin, an orthocresol novolac-type epoxy resin and a naphthol novolac-type epoxy resin; a crystalline epoxy resin such as a biphenyl-type epoxy resin, a bisphenol-type epoxy resin, a stilbene-type epoxy resin and a dihydroanthracenediol-type epoxy resin; a polyfunctional epoxy resin such as a triphenol methane-type epoxy resin and a alkyl-modified triphenol methane-type epoxy resin; an aralkyl-type epoxy resin such as a phenylene backbone-containing phenol aralkyl-type epoxy resin, a biphenylene backbone-containing biphenyl aralkyl-type epoxy resin, a phenylene backbone-containing naphthol aralkyl-type epoxy resin and a biphenylene backbone-containing naphthol biphenyl aralkyl-type epoxy resin; a naphthol-type epoxy resin such as a dihydroxynaphthalene-type epoxy resin and an epoxy resin obtained by glycidyl etherification of dihydroxynaphthalene dimer; a triazine nucleus-containing epoxy resin such as triglycidyl isocyanurate and monoallyl diglycidyl isocyanurate; and a cyclic hydrocarbon compound-modified phenol-type epoxy resin such as a dicyclopentadiene-modified phenol-type epoxy resin.

Moreover, the composition of the present invention may be diluted with a solvent before use. In view of a dissolution property of the component (A), an organic solvent may be used alone, or two or more organic solvents may be used in a mixed manner. Examples of such organic solvent(s) include alcohols such as methanol, ethanol, isopropanol and n-butanol; ketones such as acetone, methyl ethyl ketone and methyl isobutyl ketone; glycol ethers such as ethylene glycol and propylene glycol; aliphatic hydrocarbons such as hexane and heptane; aromatic hydrocarbons such as toluene and xylene; and ethers such as diethyl ether, diisopropyl ether and di-n-butyl ether.

### Method for Producing Composition

The heat-curable maleimide resin composition of the present invention may, for example, be produced as follows. That is, there may be employed, for example, a method where the cyclic imide compound and the LDS additive as well as other components, if needed, are to be combined together at given compounding ratios, followed by using a mixer or the like to thoroughly and uniformly mix, stir, dissolve, disperse and/or melt and knead them. The components may be combined together simultaneously or separately, and mixing or the like may be carried out while performing heating if necessary.

While there are no particular restrictions on a device for carrying out mixing or the like, examples thereof include a grinding machine equipped with a stirring and a heating device(s), a twin-roll mill, a triple-roll mill, a ball mill, a planetary mixer and a mass colloider. These apparatuses may be appropriately combined with one another at the time of usage.

The heat-curable maleimide resin composition of the present invention is useful as an encapsulation resin for a premolded substrate; semiconductor devices of a transistor type, a module type, a DIP type, a SO type, a flatpack type, a QFN type and a ball grid array type; a 3-dimensional structure device of a chip on wafer type (COW); and a semiconductor device having a fan-out structure. There are no particular restrictions on a method for encapsulating a semiconductor device with the heat-curable maleimide resin composition of the present invention; there may be employed a conventional molding method such as transfer molding, injection molding, compression molding, lamination molding and cast molding. Compression molding is particularly preferred.

While there are no particular restrictions on a molding (curing) condition(s) of the heat-curable maleimide resin composition of the present invention, it is preferred that the composition of the invention be heated at 120 to 250° C. for 90 sec to 4 hours. Further, it is preferred that post curing be performed at 170 to 250° C. for 1 to 16 hours.

The cured product of the heat-curable maleimide resin composition of the present invention is capable of being subjected to non-electrolytic plating via laser direct structuring; a metal layer(s) can be easily provided on the surface of or inside the cured product. Further, since the cured product of the resin composition has a low dielectric property, the cured product can be favorably used in communication devices requiring antenna circuits and three-dimensional wiring structures.

### Semiconductor Device

A semiconductor device of the present invention has the cured product of the heat-curable maleimide resin composition of the present invention, and at least part of the cured product is plated. While there are no particular restrictions on a method for plating the cured product, there may be employed, for example, a method where the surface or inner region of the cured product is to be irradiated with a laser of a wavelength selected from 248 nm, 308 nm, 355 nm, 532 nm, 1064 nm or 10,600 nm, in a way such that a desired wiring, pore diameter and depth will be achieved, followed by immersing the irradiated cured product into a plating liquid containing target metal components such as Cu, Ni and Ag. It is preferred that an output of the laser be 0.01 to 15 W, and that a scanning speed thereof be 1 to 1,000 mm/s. The plating liquid is a solution containing, for example, a complexing agent, a pH adjuster, a conducting salt and a reductant other than the target metal components; a commercially available product may be used as such plating liquid. The temperature of the plating liquid is 50 to 80° C., and an immersion time is 20 to 120 min.

### WORKING EXAMPLE

The present invention is described in greater detail hereunder with reference to working and comparative examples. However, the present invention is not limited to the following working examples.

Materials used in working and comparative examples are shown below.

### (A) Cyclic Imide Compound

(A-1) Linear alkylene group-containing maleimide compound-1 represented by the following formula (BMI-1500 by Designer Molecules Inc.; weight-average molecular weight 4,400)

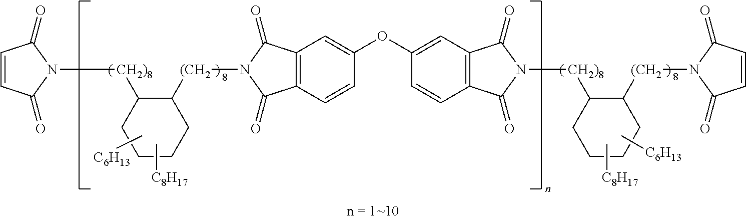

(A-2): Linear alkylene group-containing maleimide compound-2 represented by the following formula (BMI-3000 by Designer Molecules Inc.; weight-average molecular weight 16,000)

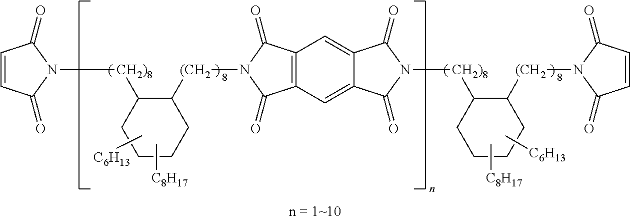

(A-3): Linear alkylene group-containing maleimide compound-3 represented by the following formula (BMI-5000 by Designer Molecules Inc.; weight-average molecular weight 30,000)

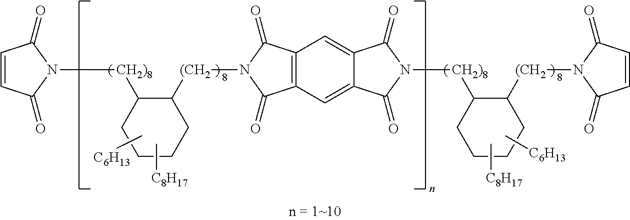

### (B) LDS Additive

LDS additive 1 (CuCr₂O₄): by Shepherd Color Japan, Inc. “EX1816” (sodium ion concentration: 16 ppm, chloride ion concentration: 14 ppm, average particle size: 0.8 μm)

Particularly, the sodium ion concentrations and chloride ion concentrations in the LDS additives 1 were measured by the following method. An aqueous dispersion was at first prepared by immersing 10 parts by mass of the LDS additive in 50 parts by mass of pure water, followed by leaving such aqueous dispersion to stand at 125±3° C. for 20±1 hours. After a given period of time had passed, this aqueous dispersion was then filtrated with a filter paper, followed by analyzing the filtrate using an atomic absorption photometer so as to obtain the sodium ion concentration. Further, the chloride ion concentration was measured by ion chromatography.

### Inorganic Filler

Silica particles: by TATSUMORI LTD. “MUF-4” (average particle size 4 μm, top cut particle size 10 μm)

### Mold Release Agent

Carnauba wax: by TOA KASEI CO., LTD. “TOWAX-131”

### Adhesion Aid

γ-glycidoxypropyltrimethoxysilane: by Shin-Etsu Chemical Co., Ltd. “KBM-403”

### Epoxy Resin

Biphenyl-type epoxy resin: by Mitsubishi Chemical Corporation “YX-4000”

### Phenol Resin Curing Agent

Aralkyl-type phenol resin: by Meiwa Plastic Industries, Ltd. “MEHC-7800SS”

### Curing Accelerator

Dicumylperoxide (DCPO): by NOF CORPORATION “PERCUMYL D”
N′-[3-[[[(dimethylamino)carbonyl]amino]methyl]-3,5,5-trimethylcyclohexyl]-N,N-dimethylurea: by San-Apro Ltd. “U-cat 3513N”

### Working Examples 1 to 6, Comparative Examples 1 to 3

The above components were combined together in accordance with the compounding ratios (parts by mass) shown in Table 1. The components combined were then melted and mixed to obtain a composition. Each composition obtained was then subjected to press molding at 175° C. for 300 sec so as to produce a cured product test piece of a size of 250×74×0.2 mm. The test piece was evaluated by the methods described below. The results thereof are shown in Table 1.

### Plating Property Evaluation

A YVO₄ laser marker (by KEYENCE CORPORATION, 1064 nm) was used to leave marks on the surface of the test piece cut into a size of 50×50 mm. This test piece was then immersed in a plating liquid at 65° C. for 30 min, the plating liquid being prepared according to the following composition. A plating property of the test piece was later analyzed.

| Plating liquid | | |
|---|---|---|
| MID Copper 100XB | 150 | mL |
| MID Copper 100AC | 18 | mL |
| MID Copper 100C | 15 | mL |
| MID Copper 100CS | 15 | mL |
| MID Copper 100G | 2 | mL |
| MID Copper 100S | 4 | mL |
| (all the above by MacDermid Performance | | |
| Solutions Japan K.K.) | | |
| 35% Formalin | 5.5 | mL |
| Pure water | 792.5 | mL |

As for the plating property, “x” was given to examples where plated areas were not observed at all; “Δ” was given to examples where discontinuities or skipped parts were observed in partially plated areas; and “∘” was given to examples where plated areas were formed in a continuous and uniform manner.

### Relative Permittivity, Dielectric Tangent

A network analyzer (E5063-2D5 by Keysight Technologies) and a stripline (by KEYCOM Corp.) were connected to the test piece cut into a size of 30×40 mm to measure a relative permittivity and a dielectric tangent thereof at a frequency of 10 GHz.

### Working Example 7

A 24-pin QFN having a lead frame size of 250×74×0.2 mm was obtained via transfer molding under a condition of 175° C./180 sec, using a composition produced in a working example 5 and a 50 μm thick polyimide film as a liner. After molding, the polyimide film on the rear surface was peeled off, thereby obtaining a molded product having the cured product of the composition produced in the working example 5.

A laser substrate cutting machine, MicroLine 5820P (by LPKF) was used to form 10 lines each having a width of 20 μm and a length of 100 μm, and 10 through holes of a size of 200 mmφ, on the cured product surface of the molded product.

This molded product was then immersed in the abovementioned plating liquid at 65° C. for 30 min, thereby obtaining a premolded substrate with the lines and through holes being plated.

As for the premolded substrate thus obtained, wired parts and through vias with the lines and through holes being plated were then confirmed to have conductivity, which indicates that a favorable plating property was achieved.

### Working Example 8

Toluene of 67 parts by mass was added to 100 parts by mass of a composition produced in a working example 6, followed by mixing them so as to obtain a varnish. A roller coater was then used to apply the varnish to a PET film having a thickness of 38 μm in a way such that the varnish would have a thickness of 50 μm after drying. Drying was then performed at 150° C. for an hour to obtain an uncured resin film.

This film was then laminated on an 8-inch wafer via lamination molding, and was cured after being treated at 180° C. for two hours. As a result of carrying out plating property evaluation on such 8-inch wafer molded via lamination molding, using a method and criteria similar to those described above, the wired parts were confirmed to have conductivity, which indicates that a favorable plating property was achieved.

TABLE 1

| | | Working | Working | Working | Working | Working | Working | Comparative | Comparative | Comparative |
|---|---|---|---|---|---|---|---|---|---|---|
| | | example 1 | example 2 | example 3 | example 4 | example 5 | example 6 | example 1 | example 2 | example 3 |
| A-1 | BMI-1500 | 100 | | | | | | 100 | | |
| A-2 | BMI-3000 | | 100 | 100 | 100 | | | | | 100 |
| A-3 | BMI-5000 | | | | | 100 | 100 | | | |
| B | EX-1816 | 22 | 38 | 12 | 22 | 22 | 8 | | 18 | 105 |
| Epoxy resin | YX-4000K | | | | | | | | 50 | |
| Curing agent | MEH-C-7800SS | | | | | | | | 50 | |
| Inorganic filler | MUF-4 | 190 | 370 | 55 | 190 | 190 | | 135 | 135 | 600 |
| Mold release | TOWAX 131 | 0.5 | 0.5 | 0.5 | 0.5 | 0.5 | 0.5 | 0.5 | 0.5 | 0.5 |
| agent | | | | | | | | | | |
| Adhesion aid | KBM-403 | 1 | 1 | 1 | 1 | 1 | 1 | 1 | | 1 |
| Curing | DCPO | 2 | 2 | 2 | 2 | 2 | 2 | 2 | | 2 |
| accelerator | U CAT3513N | | | | | | | | 2 | |

| | | | | | | | | | |
|---|---|---|---|---|---|---|---|---|---|
| Plating property | ◯ | ◯ | ◯ | ◯ | ◯ | ◯ | X | ◯ | ◯ |
| Relative permittivity (10 GHz) | 3.1 | 3.2 | 2.7 | 3.1 | 3.0 | 2.7 | 3.0 | 4.3 | 3.9 |
| Dielectric tangent (10 GHz) | 0.003 | 0.002 | 0.004 | 0.003 | 0.003 | 0.004 | 0.002 | 0.02 | 0.015 |

As is clear from the above results, since the composition of the present invention is capable of allowing a metal layer(s) to be easily formed on the surface of and/or inside the cured product thereof via a non-electrolytic plating treatment, the composition of the invention is suitable for use in a communication device requiring an electromagnetic shielding property, an antenna-equipped semiconductor device and a semiconductor device requiring a wiring layer to be formed therein.

What is claimed is:

1. A heat-curable maleimide resin composition comprising:
(A) a cyclic imide compound having, in one molecule, at least one dimer acid backbone, at least one linear alkylene group having not less than 6 carbon atoms, and at least two cyclic imide groups; and
(B) a laser direct structuring additive in an amount of 5 to 100 parts by mass per 100 parts by mass of the component (A), the laser direct structuring additive being a metal oxide having a spinel structure and represented by the following average composition formula (1):
AB₂O₄ (1)
wherein A represents one or more metal elements selected from iron, copper, nickel, cobalt, zinc, magnesium and manganese, B represents iron or chrome, provided that A and B do not both represent iron.

2. The heat-curable maleimide resin composition according to claim 1, wherein an average particle size of the component (B) is 0.01 to 5 μm.

3. The heat-curable maleimide resin composition according to claim 1, wherein the component (B) is such that after an aqueous dispersion of the component (B) is prepared by immersing 10 parts by mass of the component (B) in 50 parts by mass of pure water, and then left to stand at 125±3° C. for 20±1 hours, a sodium ion concentration in the aqueous dispersion of the component (B) is not higher than 50 ppm, and a chloride ion concentration in the aqueous dispersion of the component (B) is not higher than 50 ppm.

4. The heat-curable maleimide resin composition according to claim 1, wherein the cyclic imide compound as the component (A) is represented by the following general formula (2): 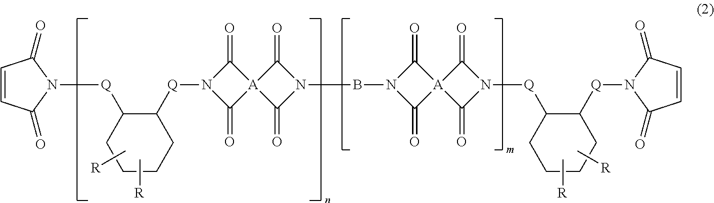
wherein A independently represents a tetravalent organic group having an aromatic ring or aliphatic ring; B represents an alkylene group that has 6 to 18 carbon atoms and a divalent aliphatic ring that may contain a hetero atom; Q independently represents a linear alkylene group having not less than 6 carbon atoms; R independently represents a linear or branched alkyl group having not less than 6 carbon atoms; n represents a number of 1 to 10; m represents a number of 0 to 10.

5. The heat-curable maleimide resin composition according to claim 4, wherein A in the general formula (2) is represented by any one of the following structural formulae: 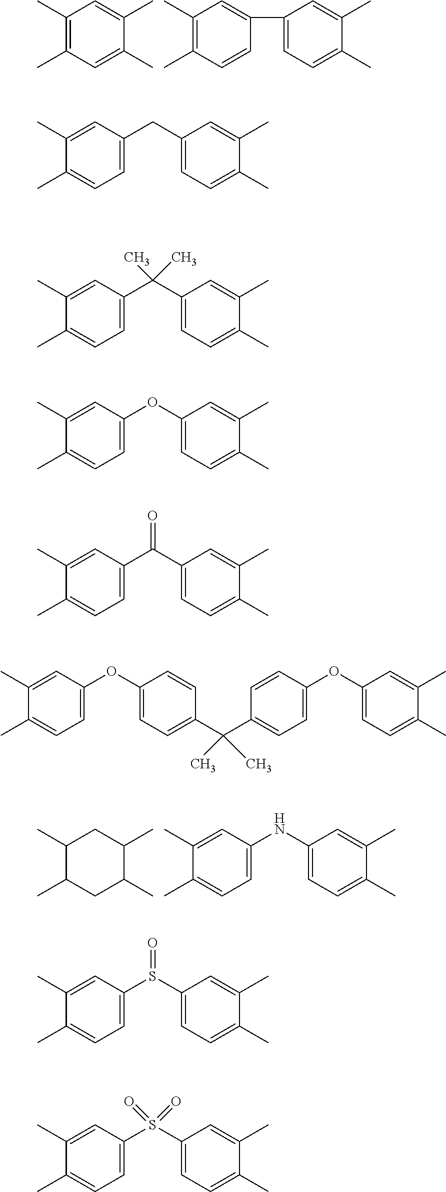
wherein bonds in the above structural formulae that are yet unbonded to substituent groups are to be bonded to carbonyl carbons forming cyclic imide structures in the general formula (2).

6. The heat-curable maleimide resin composition according to claim 1, further comprising a mold release agent, an adhesion aid and a curing accelerator.

7. The heat-curable maleimide resin composition according to claim 1, further comprising an inorganic filler.

8. A semiconductor device having a cured product of the heat-curable maleimide resin composition according to claim 1.

9. The semiconductor device according to claim 8, wherein at least part of the cured product is plated.

10. A method for producing the semiconductor device according to claim 9, wherein parts that have been irradiated with a laser are plated.
